(19) United States
(12) Patent Application Publication
(10) Pub. No.: US 2006/0172709 A1
(43) Pub. Date: Aug. 3, 2006

(54) Autoforward messaging

(76) Inventors: Mark Eyer, Woodinville, WA (US); Donald Moore, Renton, WA (US); Micheale McKay, Shoreline, WA (US); James Williamson, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/051,322

(22) Filed: Feb. 3, 2005

(51) Int. Cl. H04Q 7/20

(52) U.S. Cl. 455/90.3

(57) ABSTRACT

In one embodiment, a method comprises entering a deferred calling mode by a wireless communication unit. Thereafter, a destination of an audio, video, or text message for transmission by the wireless communication unit is provided and the message is recorded and stored within the destination within memory of the wireless communication unit for later transmission.

### FIELD

Embodiments of the invention relate to the field of wireless communications. More specifically, various embodiments of the invention relate to a wireless communication unit and method that support deferred delivery of messages when wireless service is unavailable or when requested by the user.

### GENERAL BACKGROUND

Over the past decade, wireless communications have dramatically improved business productivity and personal safety. In particular, cellular telephones now enable business employees to stay in contact with other employees, suppliers and even customers, especially in locations where normal plain old telephone system (POTS) communications are inconvenient or inaccessible. Also, they enable persons in distress to communicate with law enforcement and emergency technicians.

Unfortunately, wireless connectivity is still unavailable in a substantial number of rural and suburban areas. In fact, there are a number of areas where no type of wireless connectivity (e.g., cellular, wireless local area network “WLAN” signaling including wireless fidelity “WiFi”, etc.) is available whatsoever.

In certain situations, this lack of wireless connectivity may pose a problem, such as when a person has a spur-of-the-moment thought or idea but, due to the lack of wireless connectivity, is unable to immediately communicate the thought or idea to an intended recipient. With conventional technology, the user would be required to remember the idea and be able to fully recollect the idea once wireless connectivity is available. However, as many of us have experienced, some spur-of-the-moment ideas cannot be fully recollected at a later time. It would be possible, of course for the idea to be recorded on a voice-memo device, but the transfer of that message into the telephone system could be inconvenient and/or problematic.

Moreover, even when wireless connectivity is available, there may be moments when a person does not have time to speak at great lengths with the recipient or does not wish to directly speak with the recipient. Instead, it would be desirable to deliver a “one-way” message to the recipient.

### BRIEF DESCRIPTION OF THE DRAWINGS

The features and advantages of the invention will become apparent from the following detailed description of the invention in which:

FIG. 1A is an exemplary embodiment of a wireless system with a wireless communication unit attempting to establish wireless connectivity with a wireless signal relay unit.

FIG. 1B is an exemplary embodiment of the wireless system of FIG. 1A with the wireless communication unit establishing a wireless connection with the wireless signal relay unit.

FIG. 2 is an exemplary embodiment of the external components forming the wireless communication unit of FIGS. 1A and 1B.

FIG. 3 is an exemplary embodiment of internal logic of the wireless communication unit of FIGS. 1A and 1B.

FIG. 4 is an exemplary embodiment of a call storage portion of local memory of the wireless communication unit of FIG. 3.

FIG. 5 is an exemplary image screen of the wireless communication unit of FIG. 3 enabling the user to select a deferred delivery feature for the message.

FIG. 6 is a first exemplary flowchart of the operations associated with a deferred delivery feature of the wireless communication unit of FIGS. 2 and 3.

FIG. 7 is a second exemplary flowchart of operations associated with a deferred delivery feature of the wireless communication unit of FIGS. 2 and 3.

FIG. 8 is a third exemplary flowchart of the operations associated with a deferred delivery feature of the wireless communication unit of FIGS. 2 and 3.

FIGS. 9A-9D are exemplary image screens produced by the wireless communication unit of FIGS. 2 and 3 to enable deferred delivery of messages even when wireless connectivity is available.

FIG. 10 is an exemplary flowchart describing the general operations associated with deferred delivery of messages, including deferred delivery of messages in accordance with FIGS. 9A-9D.

### DETAILED DESCRIPTION

In general, one embodiment of the invention relates to a wireless communication unit, operating as a cellular telephone according to one embodiment, that supports deferred delivery of messages either when wireless connectivity is unavailable or when programmed by the user regardless of the availability of wireless connectivity.

Herein, certain terminologies are used to define certain features of the invention. For example, the term “user” is intended to refer to the operator of a wireless communication unit and the term “recipient” is a device that (or person who) receives a message over a wireless connection. A “message” is recorded audio, video, image or text transmitted in the form of one or more wireless packets or frames. For instance, according to one embodiment of the invention, the message may be audio placed in a given format (e.g., digital or analog) or transmitted at a given frequency range such as frequencies used for cellular, Personal Communication Systems (PCS), microwave, or satellite transmissions. A “wireless connection” is an established communication pathway to networking equipment for routing information from a wireless signal from the user to the recipient (i.e., wireless connectivity).

A “wireless communication unit” is intended to refer to any device capable of establishing a wireless connection with another device. One embodiment of a wireless communication unit includes a wireless (cellular) telephone, although other types of products may apply such as a hand-held computer for example. The wireless communication unit may be placed in a number of operating modes such as “Deferred Calling” mode when the wireless communication unit intentionally delays transmission of the stored connection information, which includes the recorded audio.

Generally, “logic” includes hardware and/or software configured to perform one or more functions. “Software” is defined as one or more instructions that when executed, cause the wireless communication unit to perform a certain function or operation. The instructions are stored in machine-readable medium, which is any medium that can store and transfer information. Examples of machine-readable medium include, but are not limited to an electronic circuit, a semiconductor memory device (volatile or non-volatile), a data storage disk (e.g. mechanical or optical hard drive) or even any portable storage media such as a diskette, a disc, tape, card, Universal Serial Bus (USB) flash drive or the like. The machine-readable medium may further include an information-carrying medium such as electrical wire, optical fiber, cable, bus, air in combination with wireless signaling technology or any combination thereof.

### I. System Architecture

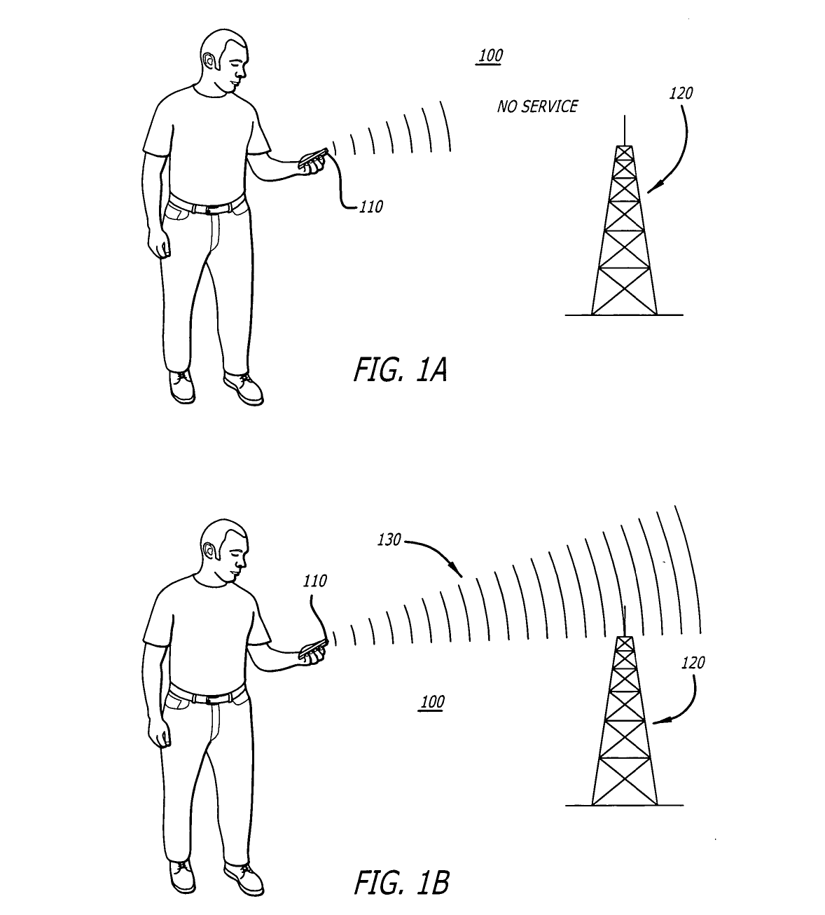

Referring to FIGS. 1A and 1B, exemplary embodiments of a wireless system 100 are shown. For one embodiment, as shown in FIG. 1A, wireless system 100 comprises a wireless communication unit 110 that is unable to achieve wireless connectivity to wireless communication units through one or more wireless signal relay units 120 operated by a service provider. In other words, the data transmission service is unavailable. Examples of a wireless signal relay unit 120 include any base station or tower maintained by a commercial cellular telephone company, a WiFi server, a satellite, or even a base station or wireless router serving one or more wireless communication units within a residence.

At this state of non-connectivity, a message may be recorded and temporarily stored within local memory of wireless communication unit 110. Once wireless connectivity is re-established between wireless communication unit 110 and wireless signal relay unit 120, as shown in FIG. 1B, the recorded message is transmitted as a message 130 to wireless signal relay unit 120 and appropriately routed therefrom. Such transmission includes appropriate formatting of the message in a wireless packet or frame prior to transmission.

Although not shown, it is contemplated that wireless communication unit 110 may communicate directly with other wireless communication units or a device supporting both wired and wireless communications. For example, the device may support a wireless connection but is coupled to a wired bus (e.g., a wide local area network “WLAN” station).

### II. Wireless Communication Unit Architecture

A. Exemplary Handset Architecture

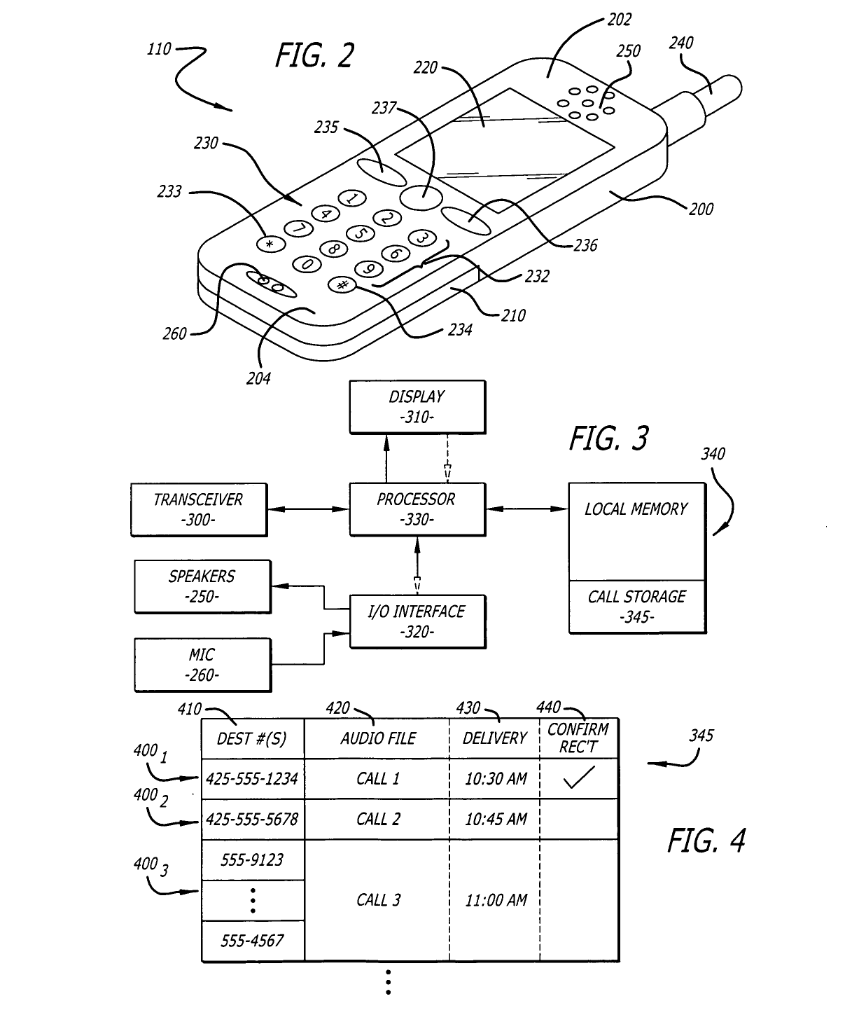

Referring now to FIG. 2, a first exemplary embodiment of exterior elements of wireless communication unit 110 is shown. Wireless communication unit 110 comprises a housing 200 made of a rigid or semi-rigid material such as hardened plastic. Housing 200 is adapted to receive a battery 210, which supplies power to internal components within housing 200.

Housing 200 is further adapted with a display 220, a keypad 230, an antenna 240, a speaker 250 and a microphone 260. As shown, speaker 250 and microphone 260 are placed near or at a top end 202 and near or at a bottom end 204 of housing 200, respectively. Speaker 250 enables the user to clearly hear audible sounds such as dial tones, ringer tones, or audio associated with incoming wireless signals. Microphone 260 receives audio in an analog format, which is subsequently digitized and stored in local memory of wireless communication unit 110.

As further shown in FIG. 2, display 220 is a liquid crystal display (LCD) that provides a visual interface for a user to configure wireless communication unit 110 to perform certain tasks. For one embodiment, such configuration may be accomplished by depressing various buttons associated with keypad 230. Keypad 230 includes a standard set of single digit number buttons (0-9) 232 as well as various symbol buttons “#” and “*” buttons 233 and 234. Other keypad buttons include a DISCONNECT button 235, a CONNECT button 236 and a MENU NAVIGATION button 237. Of course, where display 220 is a touch screen, certain tasks may be handled using display 220, thereby eliminating the need for keypad 230.

As shown, in “Normal” operating mode when wireless connectivity is established, depression of DISCONNECT button 235 terminates a communication session. Subsequent communication sessions may be established by selecting a destination (e.g., dialing a phone number) and depressing CONNECT button 236. MENU NAVIGATION button 237 enables the user to select different menu options, such as entering into a “Deferred Calling” mode, select a deferred call delivery time and the like as described below.

B. Exemplary Internal Logic Architecture

Referring to FIG. 3, an exemplary embodiment of internal logic of wireless communication unit 110 is shown. Wireless communication unit 110 comprises internal logic including one or more of the following: a transceiver 300, a display 310, an input/output (I/O) interface 320, a processor 330, and a local (internal) memory 340. Microphone 260 of FIG. 2 is electrically coupled to processor 330 via I/O interface 320. As an option, wireless communication unit 110 may further include speakers 250 if wireless communication unit 110 supports bi-directional communications.

Transceiver 300 comprises an antenna and perhaps other components to process incoming or outgoing messages. For example, according to one embodiment of the invention, transceiver 300 comprises an antenna coupled to a demodulator and/or modulator. Transceiver 300 is configured to form messages for transmission from wireless communication unit 110. Likewise, transceiver 300 is configured to receive incoming audio messages and to extract the audio for playback over speakers 250.

Display 310 provides logic (e.g., backlight and other hardware) to control LCD display screen 220 in providing the user of wireless communication unit 110 with a visual interface. I/O interface 320 provides a unidirectional or bi-directional communication path with an I/O device such as keypad 230 of FIG. 2 for example. As a result, I/O interface 320 may be adapted with a digital-to-analog converter (DAC) and/or an analog-to-digital converter (ADC) for conversion of analog signals received by microphone 260.

For one embodiment, in response to a lack of wireless connectivity or based on user interaction, processor 330 executes software to temporarily store messages targeted for a specific recipient, while delivery of the message is deferred until wireless connectivity is re-established or at a time of delivery specified by the user. The message is stored in a specific portion 345 of local memory 340, referred to hereinafter as “call storage memory” 345.

Referring now to FIG. 4, an exemplary embodiment of call storage memory 345 of wireless communication unit 110 of FIG. 3 is shown. Call storage memory 345 maintains a pending call table that comprises a plurality of entries 400₁-400_{N} (N≧1), where each entry 400₁-400_{N} comprises a destination field 410, a message field 420, a scheduled delivery time field 430 and a field 440 that indicates a file associated with a recorded message has been made transmitted.

As shown, according to one embodiment of the invention, message field 420 comprises message data recorded by the user and saved as in an appropriate file format (e.g., MP3, AVC, JPEG, etc.) or a pointer to a memory location within local memory 340 where the particular message file is stored. Destination field 410 comprises information needed for wireless communication unit 110 of FIG. 3 to establish communications with an intended recipient. For this embodiment, destination field 410 stores one or more telephone numbers for corresponding recipient(s) of the recorded audio. As shown, entry 400, includes a single destination (425-555-1234) for a recorded message (CALL1) while entry 400₃ includes multiple destinations (555-9123, . . . , and 555-4567) for the recorded message (CALL3).

As an option, call storage memory 345 includes a delivery field 430 for each entry 400₁-400_{N}. Delivery field 430 identifies the anticipated delivery time of the recorded message file associated with that particular entry. As an example, message file (CALL1) is scheduled for delivery at 10:30 A.M. Meanwhile, message file (CALL3) is scheduled for delivery around 11:00 A.M. In the event that the time of delivery lapses and the wireless communication unit still is unable to deliver the message, wireless communication unit continues to periodically attempt delivery of the message file after the prescribed time period has expired. Such attempted delivery continues until the wireless service is restored. The periodicity of the attempted delivery can be static or dynamic if set by the user.

Alternatively, although not shown, in lieu of entering a scheduled time, it is contemplated that deferring delivery of the message file may be controlled by selecting a setting that initiates delivery of the message file once the wireless service has been established.

As another option, each entry 400₁-400_{N} of call storage memory 345 includes a transmission confirmation field 440₁-440_{N}. Transmission confirmation field 440₁, . . . or 440_{N} operates to identify that the corresponding message file 420₁, . . . , or 420_{N} has been transmitted. For instance, as shown herein, the user can verify that message file 420₁ has been sent when transmission confirmation field 440₁ has been set upon receipt of an Acknowledgement signal from a relay unit for example.

It is contemplated that call storage memory 345 is non-volatile memory that is able to store the stored message file indefinitely. However, the user may have access to delete the entry or to add an additional message to the recorded file even after storage in call storage memory 345.

### III. Deferred Call Delivery Functionality

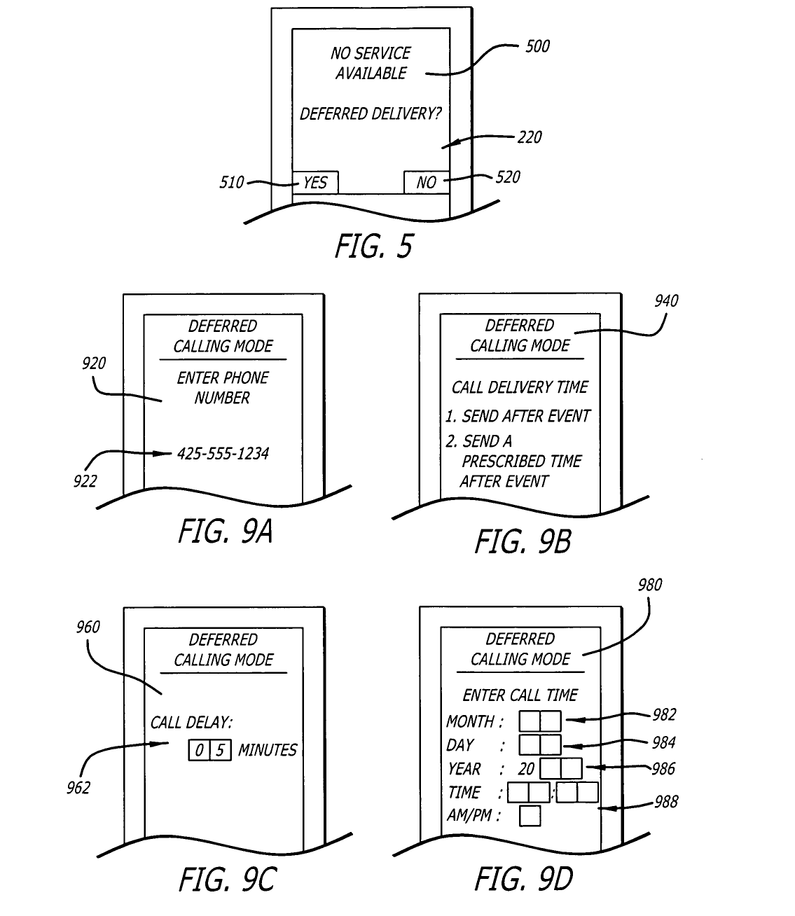

Referring to FIG. 5, an exemplary image screen of the wireless communication unit of FIG. 3 enabling the user to select a deferred delivery feature for the message is shown. Upon the phone determining that service is unavailable, an image screen 500 is illustrated on display 220 of wireless communication unit 110. Image screen 500 identifies that service is unavailable and inquires whether deferred delivery of a message is desired. Decision choices 510 and 520 are depicted in image screen 500 in order for the user to select whether or not the user wants deferred delivery of a message.

It is contemplated that one of decision boxes 510 or 520 may be selected by depressing a particular key on the keypad. For instance, the navigation button may be used to select one of the two select boxes. Upon selection of the “Yes” decision box, deferred delivery software is executed to prompt the user to record a message after an event such as a tone. Upon recording the message and no re-recording of the message is required, the message is stored in local memory. The storage may be organized using various methods such as by indexing the message files based on their destination (e.g., index by phone number, area code, etc.) or by time order of recording.

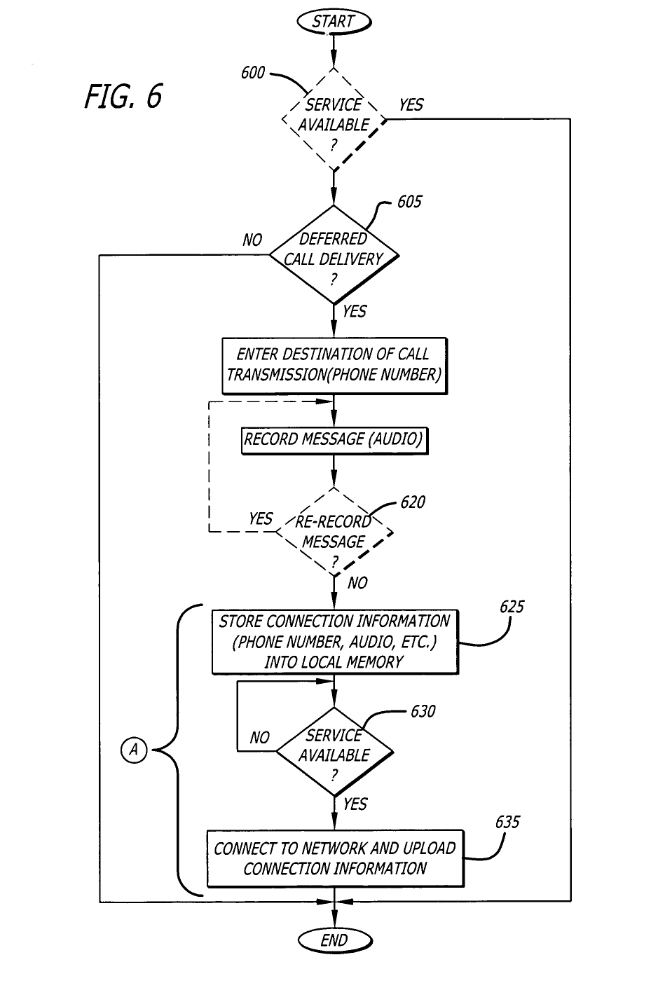

Referring now to FIG. 6, a first exemplary flowchart of the operations associated with the deferred delivery feature of the wireless communication unit of FIGS. 2 and 3 is shown. A first optional determination is made whether service is available (block 600). If service is unavailable, as measured whether signal strength reaches a threshold value, the deferred delivery software prompts the user to identify whether deferred call delivery is desired (block 605). If deferred call delivery is not desired, the process ends.

However, if deferred call delivery is desired, the user is prompted to enter the destination of the transmission (block 610). The destination may be represented by an entered phone number when the wireless communication unit is a cellular phone. Other types of destination entries include an email address, IP subnet address or the like.

Thereafter, the user is prompted to capture data (e.g., record a message such as audio), and optionally, is further prompted to re-record the message if the user is unhappy with the previously recorded message (blocks 615 and 620). Upon recording the message and entering the destination of a call (hereinafter collectively referred to as the “connection information”), the connection information is stored into local memory (block 625).

Subsequently, as shown in block 630, a determination is made whether service is available (or restored). If not, the deferred call delivery application is prompted to recheck whether service is available after a prescribed period of time has elapsed. However, if service is now available, the wireless communication unit connects to a network using the destination and uploads at least the message file of the connection information to the targeted destination (recipient) as shown in block 635.

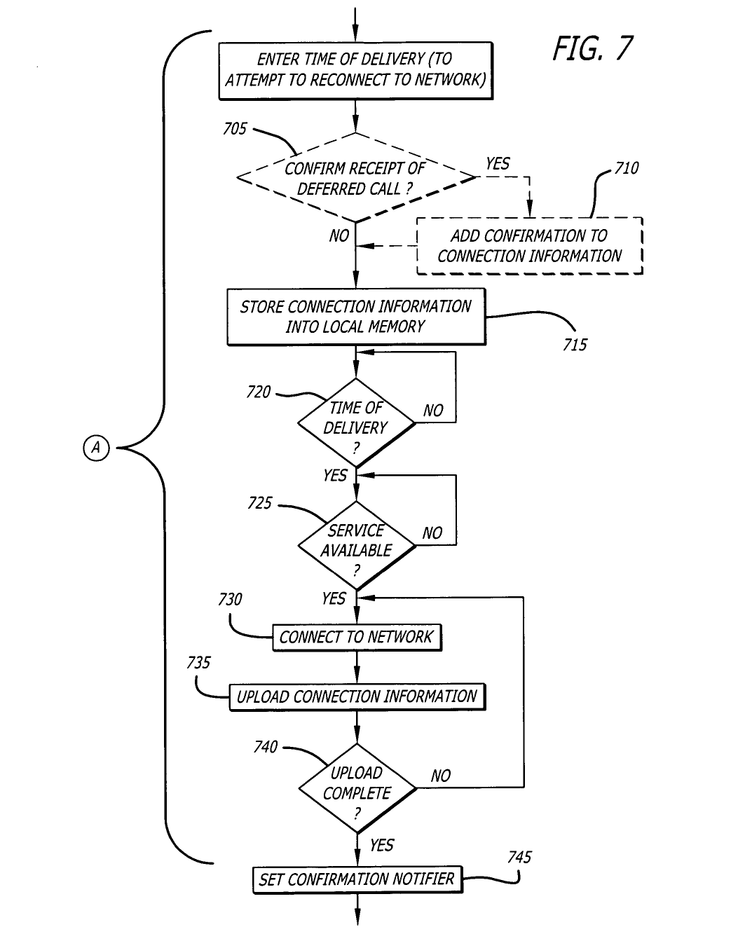

Referring to FIG. 7, a second exemplary flowchart of the operations associated with the deferred delivery feature of the wireless communication unit of FIGS. 2 and 3 is shown. Herein, in lieu of storing the connection information and connecting to a targeted network once service is available, additional features are configured to allow the user to program the time of delivery and to receive confirmation that the connection information had been transmitted.

In lieu of blocks 625, 630 and 635, the deferred call delivery application prompts the user to enter a time of delivery as to when the wireless communication unit should attempt to reconnect to a network to route a message thereto (block 700). An optional determination is made whether confirmation of receipt of the deferred call is desired (block 705), and if so, a confirmation field is activated for that particular call (block 710). Thereafter, the connection information inclusive of the time of delivery is stored and the initial resetting of the confirmation notification field is performed (block 715).

Upon determining that the time of delivery has arrived, a determination is made whether service is available (blocks 720 and 725). If service is unavailable, the deferred call delivery application rechecks the availability of service after a prescribed period of time has elapsed. If service is available, at that time, the wireless communication unit connects to the network and uploads the connection information to the wireless signal relay unit (blocks 730 and 735). The uploading of the connection information may be conducted at one time or through successive transmissions where error correction coding may be used to determine that the connection information has been completely uploaded.

Upon completion of the uploading of the connection information, the confirmation notification field is set to indicate that the connection information has been transmitted to the wireless signal relay unit (blocks 740 and 745).

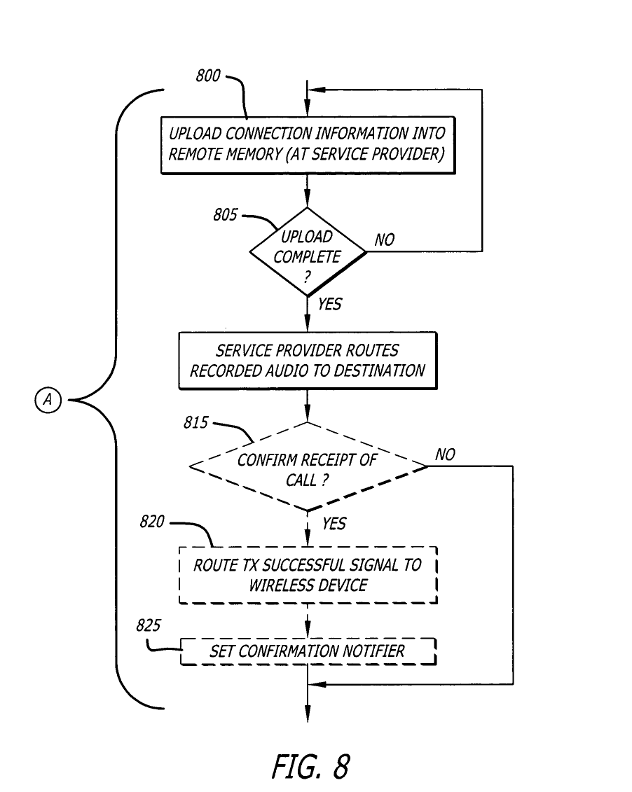

Referring to FIG. 8, a third exemplary flowchart of the operations associated with the deferred call delivery feature of the wireless communication unit of FIGS. 2 and 3 is shown. In lieu of operations set forth in blocks 625, 630, and 635, the connection information is not stored locally but rather is stored remotely. More specifically, after the destination call has been entered and the message has been recorded, the connection information is uploaded into memory at a remote location, normally a server controlled by the service provider (block 800). The service provider monitors the upload of the connection information, and upon determining that the upload is complete through error correction coding for example, the service provider routes the recorded message to the targeted destination (blocks 805 and 810).

In the event that the wireless communication unit is configured to confirm receipt of recorded transmissions, as an optional feature denoted by dashed lines, the service provider returns a signal to indicate that the transmission of the recorded message from the wireless communication unit was successful (blocks 815 and 820). Upon receipt of such signaling, the wireless communication unit sets the confirmation notification field to visually indicate to the user that the recorded message has been transmitted (block 825).

Referring now to FIGS. 9A-9D, exemplary image screens produced by the wireless communication unit of FIGS. 2 and 3 to enable deferred delivery of messages even when wireless connectivity is available are illustrated. As shown in FIG. 9A, the user may select a mode of operation referred to as “deferred calling mode”. In this operational mode, the user has the ability of transmitting a one-way message at a later point in time regardless of whether or not service is available. In FIG. 9A, the user is prompted to enter a parameter into image screen 920, namely a phone number 922 being the destination of the recorded audio. It is contemplated that in lieu of a telephone number, the user maybe prompted to enter an email address using the keypad to select the alphanumeric characters forming the email address.

As shown in FIG. 9B, after the destination has been identified and the message has been recorded, the user may be prompted to select a delivery time. According to one embodiment of the invention, as shown by entry 942 of image screen 940, the user is not prompted because the delivery time is automatically configured to be immediately after the call is disconnected. Hence, the user is not required to select any time delay.

According to other embodiments of the invention, as shown by entries 944 and 946, the delivery time is programmed by the user to occur a predetermined time after completion of a certain event. For instance, the delivery may commence a predetermined time after exiting the preferred calling mode (e.g., user closes a flip down phone to disconnect the call) or after a specific button is depressed.

Referring now to FIG. 9C, an image screen 960 is shown, which automatically sets a call delay to a predetermined time period 962, such as at five (5) minutes according to this embodiment. Time period 962 can be adjusted by the user using the keypad. As shown, the recorded message will be sent to the call destination after a five-minute time span has elapsed after exiting the deferred calling mode.

FIG. 9D, however, illustrates an image screen 980 that requires the user to enter one or more of the following parameters: month 982, day 984, year 986 and call transmission time 988. This allows the user to pre-program the wireless communication unit to send prerecorded messages to targeted recipients. For instance, the user can program his or her phone to send birthday greetings to friends and relatives, which can be programmed in advance.

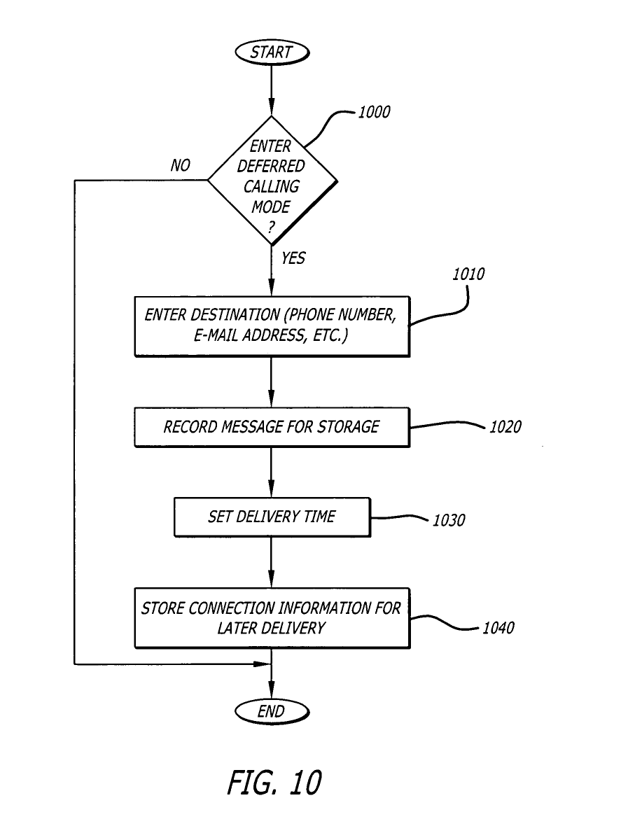

Referring to FIG. 10, an exemplary flowchart describing the general operations associated with deferred delivery of messages, including deferred delivery of messages in accordance with FIGS. 9A-9D, is shown. Initially, normally controlled by a software module, the user enters into a deferred calling mode in which the destination of a transmission (e.g., call) is selected (blocks 1000, 1010). As previously stated, the destination may include one or more telephone numbers of the target recipient, or other alternatives such as email addresses, IP subnet address and the like. The message is recorded for storage and the delivery time for transmission of the recorded message to the target destination is set (blocks 1020 and 1030). Thereafter, the destination, recorded message and delivery time (collectively the “connection information”) is stored locally within the wireless communication unit for later delivery to the wireless signal relay unit (block 1040). Such delivery may be controlled by the same software module or by different software modules.

Hence, according to one embodiment of the invention as described above, internal memory of a wireless communication unit, such as a cellular telephone for example, is used to record a destination (e.g., telephone number) dialed along with recorded audio. The cellular telephone may deliver the message by placing the call when service is available or restored as determined by a selected parameter. The selected parameter may include measured signal strength or even restoration of service for example. An advantage of non-real-time delivery of a message file is that transport protocols can guarantee delivery of the message, even in noisy signal conditions, by requesting re-transmission of any portion of the message as needed. These messages may be delivered to multiple parties or delivered repeatedly to the same party or parties.

One useful situation is using deferred delivery of messages when present on an airplane. During “Deferred Calling” mode or another selected mode, the transceiver of the wireless communication unit is disabled, but recordation of messages may be conducted. After the airplane has landed, the transceiver may be activated and wireless communication unit would subsequently delivery the recorded messages if wireless connectivity is available.

Those skilled in the art will recognize that the wireless communication unit and method of the invention have many applications, and that the invention is not limited to the representative examples disclosed herein.

What is claimed is:

1. A wireless communication unit comprising:
a housing; and
internal logic contained within the housing, the internal logic to temporarily store and defer delivery of messages targeted for wireless transmission to an intended recipient.

2. The wireless communication unit of claim 1, wherein the internal logic defers delivery of the message in response to a lack of wireless connectivity to a destination and initiates delivery of the message when wireless connectivity is re-established with the destination.

3. The wireless communication unit of claim 1, wherein the internal logic defers delivery of the message for a prescribed period of time in response to programming by a user.

4. The wireless communication unit of claim 3, wherein the prescribed period of time may be programmed according to a future date and time.

5. The wireless communication unit of claim 1, wherein the internal logic comprises a local memory to contain a pending call table that comprises a plurality of entries, each entry comprises (i) a message field including one of a message file comprising audio, video, or text recorded by the user and a pointer to a memory location within the local memory where the message file is stored, and (ii) a destination field including information needed to establish communications with the intended recipient.

6. The wireless communication unit of claim 5, wherein the information contained in the destination field includes a telephone number.

7. The wireless communication unit of claim 5, wherein the information contained in the destination field includes an email address.

8. The wireless communication unit of claim 5, wherein each entry of the pending call table stored within the local memory of the internal logic further comprises a scheduled time field that identifies an anticipated delivery time of the message file associated with that entry.

9. The wireless communication unit of claim 5, wherein each entry of the pending call table stored within the local memory of the internal logic further comprises a confirmation identification field to identify that the message file has been delivered to the intended recipient.

10. A method comprising:
entering a deferred calling mode by a wireless communication unit;
entering a destination of a message for transmission by the wireless communication unit;
recording the audio; and
storing the message for transmission to the destination within memory of the wireless communication unit.

11. The method of claim 10, wherein the destination is a telephone number.

12. The method of claim 10, wherein the destination is an Internet address.

13. The method of claim 10, wherein prior to storing the audio, the method further comprises setting a delivery time for transmission of the message to the destination.

14. The method of claim 13, wherein the storing of the message further includes storing of the message along with the destination and the delivery time within the wireless communication unit.

15. The method of claim 14 further comprising:
uploading the message to the destination in response to re-establishment of wireless connectivity with a recipient using the destination where the wireless communication unit entered into the deferred calling mode in response to a lack of wireless connectivity with the recipient.

16. Embodied within a machine-readable medium executed by a processor of a wireless communication unit, a software comprising:
a first module to cause the wireless communication unit to enter into a deferred calling mode when wireless connectivity is unavailable to a recipient, and to cause storage of message recorded by a user and the destination of the audio; and
a second module to upload the recorded message to the destination when wireless connectivity is available to the relay unit.

17. The software of claim 16, wherein the machine-readable medium being contained within a cellular telephone being the wireless communication unit.

18. The software of claim 16, wherein the first module to further cause storage of an anticipated delivery time of the message.

19. The software of claim 16, wherein the first module to further cause storage of a confirmation identifier to identify that the message has been transmitted to the relay unit.
